(19) United States
(12) Patent Application Publication
(10) Pub. No.: US 2026/0108881 A1
(43) Pub. Date: Apr. 23, 2026

(54) EWOD DEVICE WITH PARTICLE-EMBEDDED POLYMER COATING

(71) Applicant: Seagate Technology LLC, Fremont, CA (US)

(72) Inventors: Li Hong ZHANG, Singapore (SG); Barish CHAKRAVARTY, Singapore (SG); Xiong LIU, Singapore (SG); Brendon Leong SHI WEI, Singapore (SG); Bing Rui SIM, Singapore (SG); Siew Ming NG, Singapore (SG)

(21) Appl. No.: 18/919,087

(22) Filed: Oct. 17, 2024

(51) Int. Cl. B01L 3/00; G01N 27/447

(52) U.S. Cl. CPC B01L 3/50273; G01N 27/44756; B01L 2300/161; B01L 2400/0427

(57) ABSTRACT

The technology disclosed herein provides an electrowetting on dielectric device (EWOD). Implementation of the EWOD disclosed herein includes a substrate, an electrode layer configured on top of the substrate, a dielectric layer configured on the electrode layer, wherein the dielectric layer comprises polymers embedded with miniscule-sized particles, a top plate, and a micro-fluidic channel configured between the top plate and the dielectric layer comprises a nano-pattered top surface. In one implementation, the EWOD device includes a hydrophobic layer on top of the dielectric layer.

### BACKGROUND

Digital microfluidic technology is a novel microscale liquid processing technology in which ultra-small droplets can be operated. In digital microfluidics, especially in the electrowetting on dielectric (EWOD) system, each droplet acts as an independent reactor, which enables a wide range of multiple parallel biological and chemical reactions at the microscale. The term “electrowetting” describes the effects of an electric field on the surface tension of a liquid. By decreasing the surface tension, the liquid distributes over a surface that initially repels the drop and preferably simultaneously represents an electrode. By increasing the surface tension, the liquid contracts and forms a rather spherical drop. Therefore, the liquid may be termed “electrically inducible.” In the case of a single drop, the surface tension modification results in a change of the contact angle with which the drop wets the bottom surface. EWOD digital microfluidics reduces reagent and energy consumption, accelerates analysis, enables point-of-care diagnostic, simplifies integration with sensors.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following, more particular written Detailed Description of various implementations as further illustrated in the accompanying drawings and defined in the appended claims.

The technology disclosed herein provides an electrowetting on dielectric device (EWOD). Implementation of the EWOD disclosed herein includes a substrate, an electrode layer configured on top of the substrate, a dielectric layer configured on the electrode layer, wherein the dielectric layer comprises polymers embedded with miniscule-sized particles, a top plate, and a micro-fluidic channel configured between the top plate and the dielectric layer comprises a nano-pattered top surface. In one implementation, the EWOD device includes a hydrophobic layer on top of the dielectric layer.

These and various other features and advantages will be apparent from a reading of the following Detailed Description.

### BRIEF DESCRIPTIONS OF THE DRAWINGS

A further understanding of the nature and advantages of the present technology may be realized by reference to the figures, which are described in the remaining portion of the specification. In the figures, like reference numerals are used throughout several figures to refer to similar components. In some instances, a reference numeral may have an associated sub-label consisting of a lower-case letter to denote one of multiple similar components. When reference is made to a reference numeral without specification of a sub-label, the reference is intended to refer to all such multiple similar components.

FIG. 1 illustrates an example electrowetting on dielectric (EWOD) device including a single-layer particle embedded polymer coating.

FIG. 2 illustrates an example operating process for applying particle-embedded polymer can be applied on EWOD devices.

FIG. 3 illustrates alternative example operations for making a particle-embedded polymer single layer coating.

FIG. 4 illustrates and an example schematic of making a particle-embedded polymer from particle-monomer dispersion.

FIG. 5 illustrates an example graph of the dielectric constant of the particle-embedded polymer layer vs. concentration of the particles using an example of TiO₂ dispersed in a polytetrafluoroethylene (PTFE) layer.

FIG. 6 illustrates an example schematic of a particle-embedded polymer with high particle concentration near the EWOD electrode.

FIG. 7 illustrates example operations for making a particle-embedded polymer single layer coating with concertation of the particles varying based at various depths.

FIG. 8 illustrates an example schematic of a two-layer coating in EWOD, with the dielectric layer a particle-embedded polymer.

### DETAILED DESCRIPTION

The technology disclosed herein relates to electrowetting on dielectric (EWOD) system. EWOD has wide applications in bioscience and DNA writing (synthesis) for DNA storage which involves travelling, merging, washing and separation of microfluids containing DNA strands or regents. An EWOD system may include actuation electrodes covered with a dielectric layer and a hydrophobic overcoat. An EWOD system may need to actuate the microdroplets at a low voltage, which is advantageous in reducing droplet heating and evaporation, minimizing the droplet size to increase electrode density, and improving energy efficiency and device longevity. Therefore, the combined dielectric & hydrophobic layers need to be thin and have high dielectric strength/constant (dielectric layer) and good hydrophobicity on the surface.

In an implementation of an EWOD system, the EWOD performance may be achieved using two layers: the dielectric layer and the hydrophobic layer. However, such two-layer system has drawbacks, including that the hydrophobicity solely depends on the chemistry of the hydrophobic layer, and therefore, such EWOD system lacks flexibility. Furthermore, some hydrophobic materials may have poor adhesion with the dielectric layer, which limits the selection of hydrophobic materials. Additionally, gaps or defects may exist between the dielectric and hydrophobic layers, thus downgrading the performance. Similarly, such multi-layers EWOD system results in complicated structure and higher cost.

For EWOD devices, having a high dielectric constant is important for the dielectric layer. Specifically, dielectric constant of the dielectric layer is proportional to the EWOD force. Here the EWOD force refers to the force exerted on a droplet on the EWOD surface due to the interaction between an electric field and the dielectric layer beneath the droplet. This force is responsible for manipulating the droplet's movement and shape on the surface, ultimately enabling precise control in various microfluidic applications.

The implementations disclosed herein provide an electrowetting on dielectric device (EWOD) with particle-embedded polymers for EWOD coatings to obtain high dielectric purpose and high hydrophobicity of the coating. Specifically, the embedded particles may be nano to micro-sized particles (hereinafter referred to as “miniscule-sized particles”) of material of high dielectric constant. In various implementations, the size of these miniscule-sized particles may be 50 nanometers to 5 micrometers. Specifically, implementations disclosed herein select the size of the particles depending on the size of the droplet—the smaller the droplet, the smaller the size of the particles. The actual sizes of the miniscule-sized particles to be selected may be determined based on the preferred particle mixing ratio, which also determines the dielectric constant of the coating, and the optimum water contact angle of the droplet.

The miniscule-sized particles may also have moderate to high dielectric strength. Example nano particles include Ta2O5, TiO2, ZrO2, HfO2, Si, SiNx, CdO, CaO, or some composites such as CaCu3Ti4O12, which have the dielectric constant ranging from 7.5-110. The proposed solutions simplify the coating fabrication process for EWOD devices, which can potentially reduce cost. Implementations disclosed here also reduce the number of layers of the coating from two to one (Single layer coating to meet the dielectric and hydrophobic properties). By using the single-layer coating, the concern of air gaps at the interface between the dielectric layer and the hydrophobic layer can be eliminated, which helps reduce the operating voltage and improve the dielectric strength of the coating.

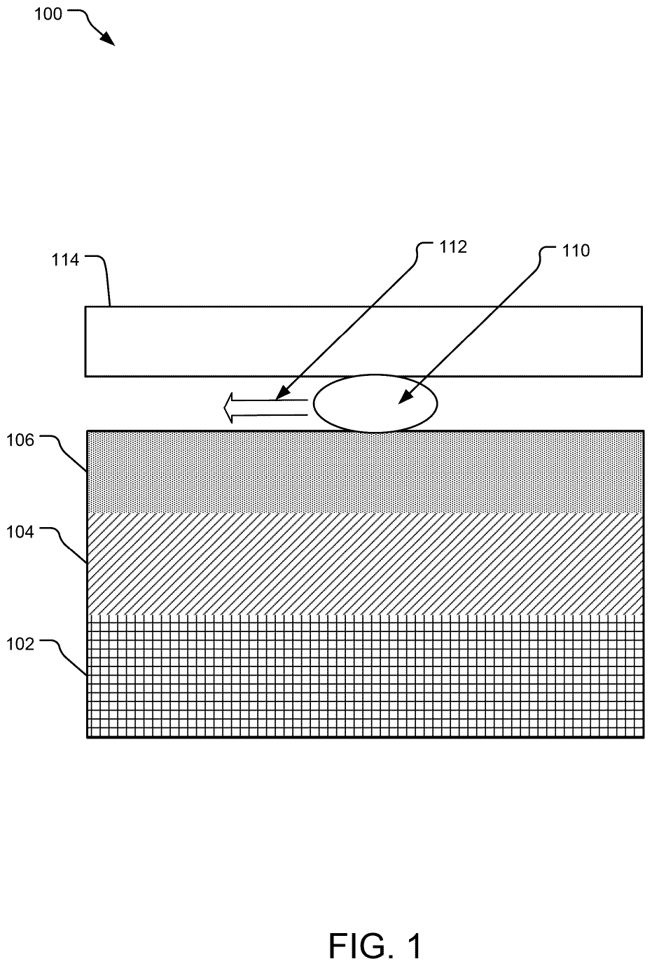

Now referring to the disclosed implementations, FIG. 1 illustrates an electrowetting on dielectric (EWOD) device 100 including a particle embedded polymer coating in the manner disclosed herein. Specifically, the EWOD device 100 may include a substrate 102, an electrode layer 104, and a single particle-embedded polymer coating 106 formed on the electrode layer 104. The substrate 102 supports the functional layers of the EWOD device 100. In one implementation, the substrate 102 may be transparent and made of glass. The particle-embedded polymer coating 106 may be embedded with particles that are nano sized materials of high dielectric constant. Specifically, the use of particle-embedded polymers for EWOD coatings provides high dielectricity and high hydrophobicity of the coating.

The table I disclosed below lists some of the materials that can be used for the solid particles used to create the particle-embedded polymer coating 106.

TABLE I

| Material | Dielectric Constant |
|---|---|
| TiO2 | 80-110 |
| Ta2O5 | 25-60 |
| ZrO2 | 32 |
| HfO2 | 18-25 |
| Si | 11.7 |
| CdO | 21 |
| CaO | 11.8 |
| SiNx | 7.5 |
| BaTiO3 | 50-4000 |

As shown above, these particles have moderate to high dielectric strength. One or the other of the above materials may be used based on the cost, dielectric constant, and compatibility of the material with the material of the hydrophobic layer. In one implementation, the particle-embedded polymers layer is embedded with one of Ta2O5, TiO2, ZrO2, HfO2, Si, SiNx, CdO, CaO. Alternatively, the particles may be made of some other composites such as CaCu3Ti4O12, which have the dielectric constant ranging from 7.5-110.

In one implementation, the embedded particles may be coated with materials which have high chemical compatibility to the polymer matrix. Such embedding may facilitate dispersion of the nano particles in the polymer matrix. The materials used to coat the nano particles may be, for example, silanes, silane-based compounds, polyethylene, or other kinds of polymers which have comparable hydrophobicity with the polymer matrix. The coating of the embedded particles may be achieved using, for example, vapor deposition, evaporation, or sol-gel processes. Embedding the particles in the polymer coating also adds some roughness on the surface, which may enhance the water contact angle (WCA) of the coating due to Cassie-Baxter effect. High WCA can enhance movements of the droplet 110 in terms of speed at low voltage. Thus, providing particle-embedded polymer coating allows reducing the voltage provided by the electrode layer 104, thus providing high electrode density, energy efficiency and better reliability and stability of the EWOD system.

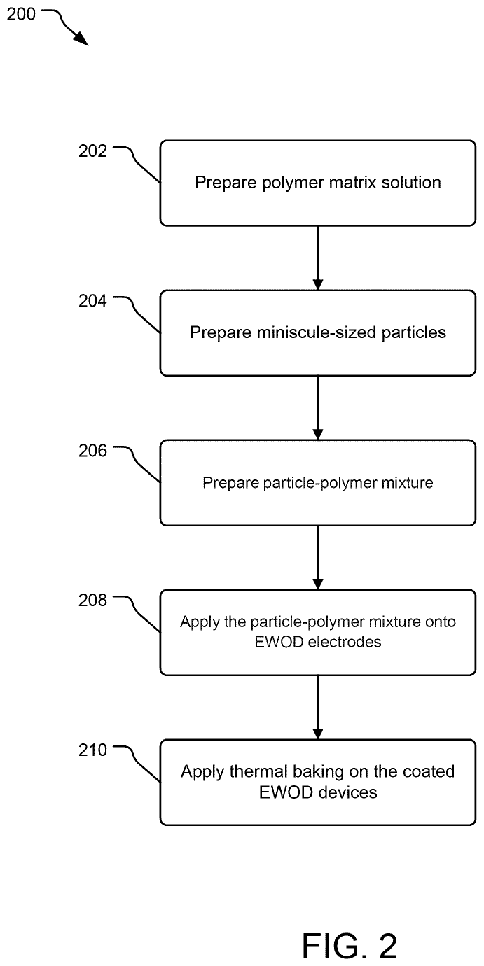

The particle-embedded polymer can be applied on EWOD devices using techniques such as spray coating, spin coating, dip coating, etc. An example operating process for applying particle-embedded polymer can be applied on EWOD devices is disclosed below in FIG. 2.

A droplet 110 may be deposited on the particle-embedded polymer coating 106. Specifically, the droplet 110 may be located between the particle-embedded polymer coating 106 and a top glass surface 114. The droplet 110 may be moved in the direction 112 due to the electrowetting effect. Specifically, when an electric field is applied to the particle-embedded polymer coating 106, it generates electric charges (electrostatic forces) at the interface between the droplet 110 and the particle-embedded polymer coating 106. These electrostatic forces cause a reduction of a contact angle of the droplet 110 to the surface of the dielectric layer 104. The droplet 110 may be of an aqueous or water-based liquid or of a non-aqueous liquid. For example, aqueous liquids may be distilled water, water-based biofluids, or water-based chemical solutions. On the other hand, non-aqueous liquids include DMSO, ethylene glycol, formamide, γ-butyrolactone, N-methyl formamide, etc.

FIG. 2 illustrates an operating process 200 for applying particle-embedded polymer can be applied on EWOD devices. An operation 202 prepares the polymer matrix solution. For example, the polymer matrix solution may be a material having high hydrophobicity but low dielectric constant. Example of such materials are Cytop, PTFE, Parylene, PDMS, etc.

An operation 204 prepares the nanoparticles for embedding in the polymer solution. For example, the nanoparticles may be surface coated for better dispersion in the polymer matrix. Subsequently, an operation 206 prepares the particle-polymer mixture to ensure good dispersion and separation of the particles in the matrix. An operation 208 applies the particle embedded polymer mixture onto EWOD electrodes. For example, the particle embedded polymer mixture maybe applied to the EWOD electrodes using coating, spin coating, dip coating, or other techniques. An operation 210 applies thermal backing to the electrodes coated with the embedded polymer mixture. The thermal baking lets the solvent evaporate and ensures good adhesion, durability and the smoothness of the coating.

Embedding the particulate compounds in the polymer matrix to increase the dielectric constant of the polymer matrix. In one implementation, the particle-embedded polymer can be used as the dielectric layer and hydrophobic layer, or single-layer coating.

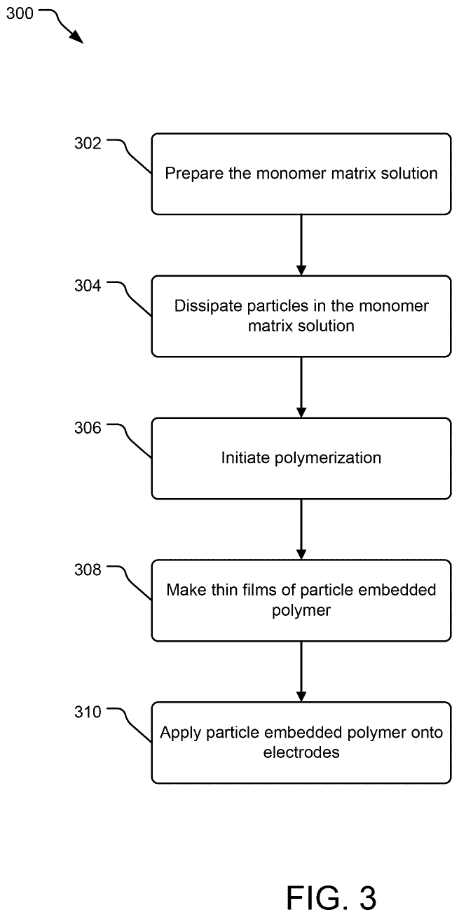

FIG. 3 illustrates alternative operations 300 for making a particle-embedded polymer single layer coating. An operation 302 prepares the monomer matrix solution. For example, the polymer matrix solution may be a material such as Octamethylcyclotetrasiloxane, which is the monomer for PDMS (Polydimethylsiloxane), monochloro para-xylylene, which is the monomer of Parylene, etc. At operation 304, the particles are dispersed in the monomer matrix. In one implementation, the surface of the particles may be coated before such dispersion. An operation 306 initiates the polymerization to form the particle-embedded monomer solution.

At operation 308, the particle-embedded polymer can be made into thin films. Subsequently, an operation 310 applies the thin film onto EWOD electrodes. In one implementation, such application of thin films may be done using lamination.

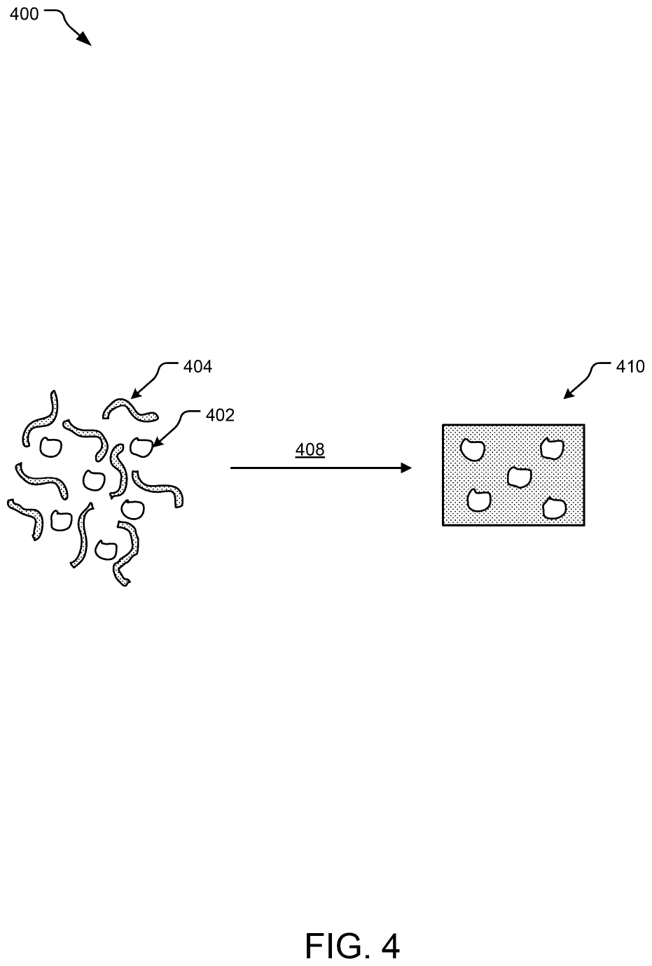

FIG. 4 illustrates and an example schematic 400 of making a particle-embedded polymer from particle-monomer dispersion. Specifically, as shown particles 402 are dispersed into monomers 404. A polymerization operation 408 generates the particle-embedded polymer 410 that can be applied to electrodes.

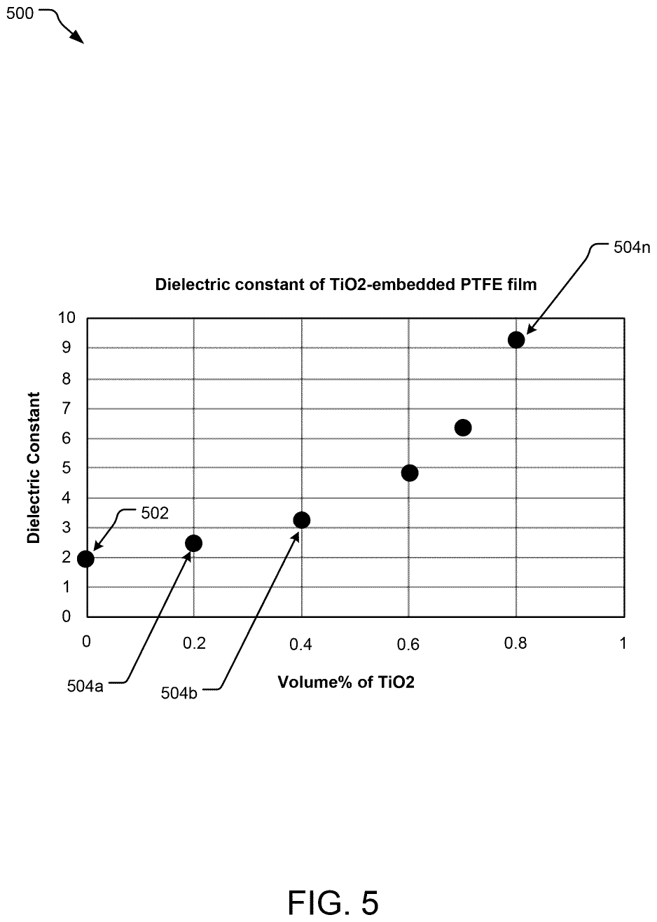

FIG. 5 illustrates a graph 500 of the dielectric constant of the particle-embedded polymer layer vs. concentration of the particles using an example of TiO₂ dispersed in a polytetrafluoroethylene (PTFE) layer. The graph 500 is illustrated with the dielectric constant of the particle-embedded polymer layer on the y-axis and the concentration of the TiO₂ dispersed in a polytetrafluoroethylene (PTFE) layer on the x-axis. Specifically, at 502, there are no particles embedded in the polymer layer. The concentration of the embedded particles, as given by volume percentage of TiO₂ is illustrated by 504a, 504b, . . . , 504n. As shown, as the concentration of the TiO₂ dispersed in a polytetrafluoroethylene (PTFE) layer increase, so does the dielectric-constant of the particle-embedded polymer layer. Generally, the single layer coating has the same breakdown voltage compared to two-layer coating of the same components and volume ratio.

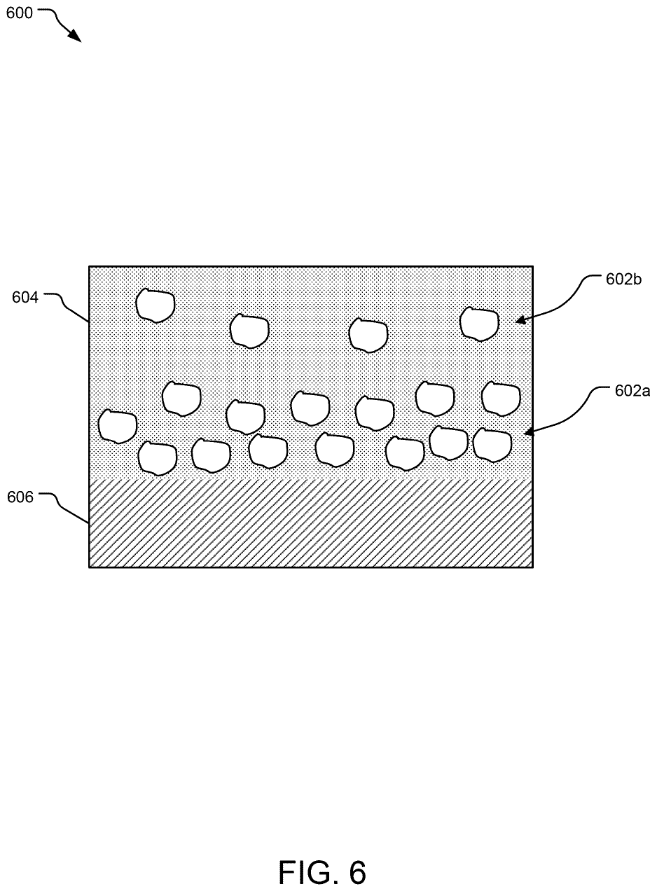

In alternative implementations, the single-layer particle-embedded polymer coating can also be made with a gradual change of the particle concentration with higher concentration near the electrode. FIG. 6 illustrates a schematic 600 of such a particle-embedded polymer with high particle concentration near the EWOD electrode. Specifically, as shown here, the concentration of embedded particles 602 in the polymer coating 604 is higher near the EWOD electrode layer 606, as illustrated by 602a. Compared to that the concentration of the embedded particles 602 in the polymer coating 604 is lower away the EWOD electrode layer 606, as illustrated by 602b.

Such single-layer particle-embedded polymer coating with higher concentration near the electrode provides an advantage of keeping the dielectric constant high near the electrode while maximizing the hydrophobicity of the surface, which can enhance the efficiency of droplet movements.

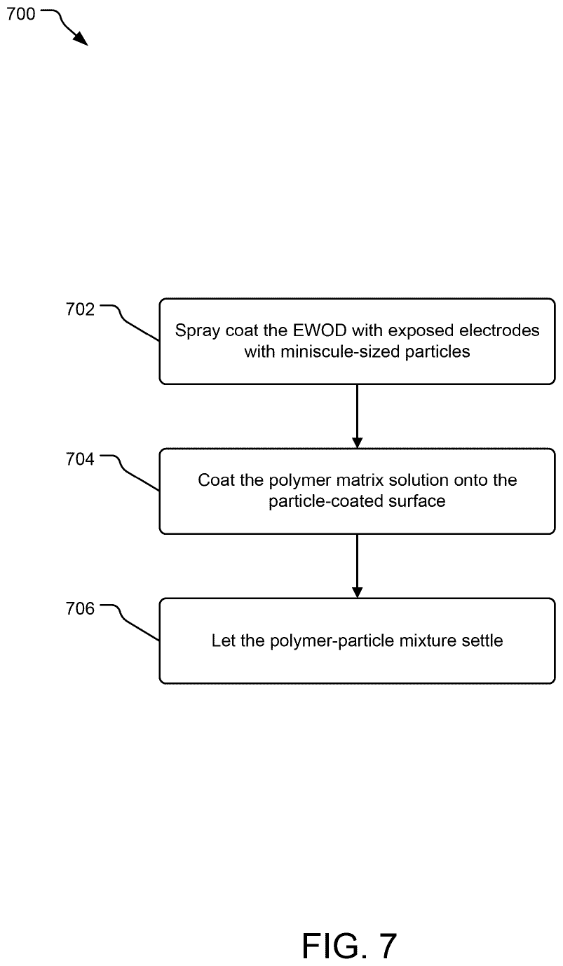

FIG. 7 illustrates alternate operations 700 for making a particle-embedded polymer single layer coating with concertation of the particles varying based at various depths. An operation 702 may spray coat the EWOD with exposed electrodes with nano particles using high pressure spray. Subsequently, an operation 704 may coat the polymer matrix solution onto the particle-coated surface. In one implementation, an operation 706 may let the polymer-particle mixture settle for some time on the electrode of the EWOD, so the heavier particles may settle to the bottom near the surface of the electrode.

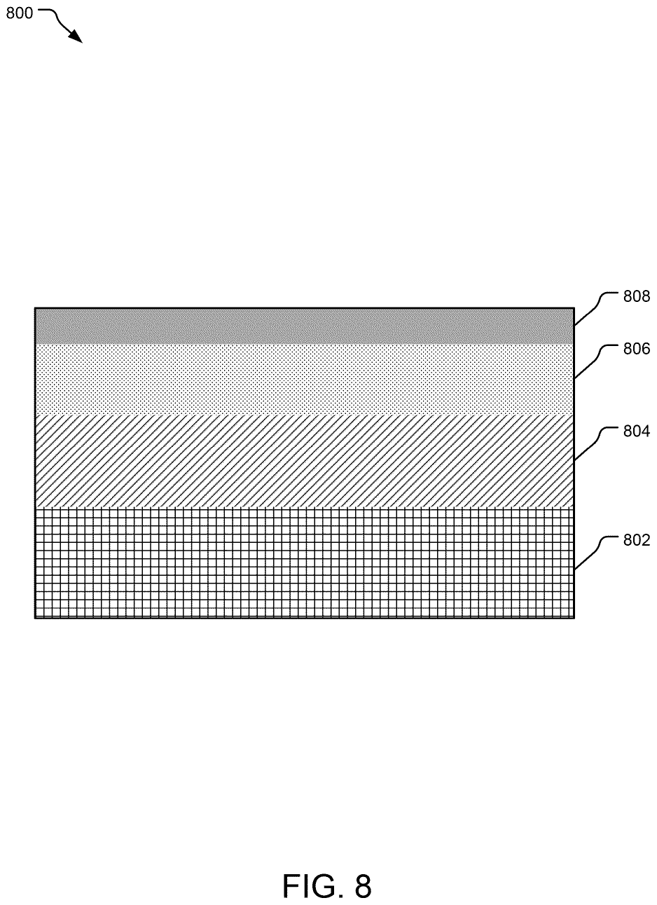

FIG. 8 illustrates a schematic 800 of a two-layer coating in EWOD, with the dielectric layer a particle-embedded polymer. Specifically, the illustrated implementation of the EWOD includes a two-layer coating with the dielectric layer being a polymer such as SU-8, polydimethylsiloxane (PDMS), which are normally prepared by spin coating. Thus, the EWOD disclosed herein includes a substrate 802, an electrode layer 804, a dielectric layer 806, and a hydrophobic layer 808. In such implementation, the dielectric layer 806 may be embedded with the proposed particulate compounds (Ta₂O₅, TiO₂, ZrO₂, HfO₂, Si, SiNx, CdO, CaO, etc.) to enhance the dielectric constant of the dielectric layer. In one implementation, the volume percentage (%) of the particles embedded in the dielectric polymer matrix layer 806 may vary from 20-80%.

The implementations of the EWOD disclosed herein simplifies the coating fabrication process for EWOD devices, which can potentially reduce cost. This may reduce the number of layers of the coating from two to one (Single layer coating to meet the dielectric and hydrophobic properties). By using the single-layer coating, the concern of air gaps at the interface between the dielectric layer and the hydrophobic layer can be eliminated, which helps reduce the operating voltage and improve the dielectric strength of the coating. Furthermore, the single-layer coating can potentially reduce the operating voltage and total coating thickness, which may benefit high electrode density (downsizing the EWOD devices).

Implementations of the particle-embedded polymer coating can create a certain surface roughness due to Cassie-Baxter effect, which, upon optimization, can improve the water-contact-angle (WCA) of the coating surface, and thus, facilitate droplet movement. Additionally, the implementations using double-layer coating having both the dielectric layer and hydrophobic layer as illustrated in FIG. 7 may also increase the dielectric constant of the dielectric layer.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A device, comprising:
a substrate;
an electrode layer configured on top of the substrate;
a dielectric layer configured on the electrode layer, wherein the dielectric layer comprises polymers embedded with miniscule-sized particles;
a top plate; and
a micro-fluidic channel configured between the top plate and the dielectric layer comprises a nano-pattered top surface.

2. The device of claim 1, wherein the polymers embedded with miniscule-sized particles include miniscule-sized particles having dielectric constant in the range of 7.5 to 110.

3. The device of claim 1, wherein the polymers embedded with miniscule-sized particles may be at least one of Ta₂O5, TiO₂, ZrO₂, HfO₂, Si, SiNx, CdO, or CaO.

4. The device of claim 1, wherein the polymers embedded with miniscule-sized particles may be a CaCu₃Ti₄O₁₂ composite.

5. The device of claim 1, wherein the miniscule-sized particles are coated with materials with hydrophobicity substantially similar to the hydrophobicity of the miniscule-sized particles.

6. The device of claim 1, wherein the miniscule-sized particles are coated with at least one of silanes, silane-based compounds, and polyethylene.

7. The device of claim 1, wherein the miniscule-sized particles are embedded in the dielectric layer using at least one of spray coating, spin coating, and dip coating.

8. The device of claim 1, wherein the miniscule-sized particles include at least one of Cytop, PTFE, Parylene, PDMS.

9. The device of claim 1, wherein the dielectric layer has a graded concentration of miniscule-sized particles with concentration near the electrode layer being higher than the concentration near top surface of the dielectric layer.

10. The device of claim 1, further comprising a hydrophobic layer on top of the dielectric layer.

11. An electrowetting on dielectric device (EWOD), comprising:
a substrate;
an electrode layer configured on top of the substrate;
a dielectric layer configured on the electrode layer, wherein the dielectric layer comprises polymers embedded with miniscule-sized particles;
a top plate;
a micro-fluidic channel configured between the top plate and the dielectric layer comprises a nano-pattered top surface; and
a hydrophobic layer on top of the dielectric layer.

12. The EWOD of claim 11, the polymers embedded with miniscule-sized particles include miniscule-sized particles having dielectric constant in the range of 7.5 to 110.

13. The EWOD of claim 11, wherein the polymers embedded with miniscule-sized particles may be at least one of Ta₂O5, TiO₂, ZrO₂, HfO₂, Si, SiNx, CdO, or CaO.

14. The EWOD of claim 11, wherein the miniscule-sized particles are coated with materials with hydrophobicity substantially similar to the hydrophobicity of the miniscule-sized particles.

15. The EWOD of claim 11, wherein the miniscule-sized particles are coated with at least one of silanes, silane-based compounds, and polyethylene.

16. The EWOD of claim 11, wherein the miniscule-sized particles are embedded in the dielectric layer using at least one of spray coating, spin coating, and dip coating.

17. An electrowetting on dielectric (EWOD) system, comprising:
a substrate;
an electrode layer configured on top of the substrate;
a dielectric layer configured on the electrode layer, wherein the dielectric layer comprises polymers embedded with miniscule-sized particles having dielectric constant in the range of 7.5 to 110;
a top plate; and
a micro-fluidic channel configured between the top plate and the dielectric layer comprises a nano-pattered top surface.

18. The system of claim 17, wherein the polymers embedded with miniscule-sized particles may be at least one of Ta₂O5, TiO₂, ZrO₂, HfO₂, Si, SiNx, CdO, or CaO.

19. The system of claim 17, wherein the miniscule-sized particles are coated with materials with hydrophobicity substantially similar to the hydrophobicity of the miniscule-sized particles.

20. The system of claim 17, wherein the miniscule-sized particles are embedded in the dielectric layer using at least one of spray coating, spin coating, and dip coating.
